(19) United States
(12) Patent Application Publication
(10) Pub. No.: US 2008/0211209 A1
(43) Pub. Date: Sep. 4, 2008

(54) AUTO PSIR FOUR DOOR ELEMENT TRAPEZOIDAL COVER SYSTEM

(76) Inventors: Gregg S. Evans, Windsor (CA); Shin Mizusaki, Troy, MI (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/024,509

(22) Filed: Feb. 1, 2008

Related U.S. Application Data
(60) Provisional application No. 60/887,898, filed on Feb. 2, 2007.

(51) Int. Cl. B60R 21/20

(52) U.S. Cl. 280/728.3

(57) ABSTRACT

A trapezoidal automotive PSIR door system including one or more lateral doors including two or more tear lines disposed at first and second oblique angles relative to a longitudinal direction of an automobile. The PSIR door system further includes a forward door including one or more tear lines in common with one of the lateral door tear lines, and a rearward door including one or more tear lines in common with another one of the lateral door tear lines.

### RELATED APPLICATIONS

This application claims benefit of priority of Provisional Application Ser. No. 60/887,898 filed Feb. 2, 2007, hereby incorporated by reference in its entirety.

### BACKGROUND OF INVENTION

a. Field of Invention

The invention relates generally to the manufacture of automotive Passenger Side Inflatable Restraint (PSIR) components, and more particularly to an apparatus and method for facilitating optimal deployment of a PSIR door and the associated air bag.

b. Description of Related Art

As is known in the art, Passenger Side Inflatable Restraint (PSIR) doors generally include a “U” or “H” pattern for facilitating adequate opening of the PSIR doors during air bag deployment, as well as for allowing deployment of the passenger air bag at an optimal trajectory. For example, referring to FIG. 1, an “H” type automotive PSIR door system is illustrated and generally includes forward and rearward PSIR doors 10, 12 hingedly connected at 14 to an air bag chute 16. Each door 10, 12 may be vibration welded to chute 16 by a hinge weld flange 18. As illustrated, forward PSIR door 10 may be the door adjacent a windshield (34 in FIG. 3) and rearward PSIR door 12 may be the door closest to the passenger. PSIR doors 10, 12 may be generally formed from the outer layer of an instrument panel 20 having weakening score lines 22 formed therein for allowing detachment of each door during air bag deployment.

The “U” and “H” type automotive PSIR door systems are unique in that compared to a driver's side air bag 24 (see FIG. 2) which opens at a generally perpendicular trajectory T relative to the air bag doors 26, 28, passenger air bag 25 (see FIG. 3) must open at a substantially oblique trajectory T′ relative to the air bag doors 10, 12. Whereas the driver's side air bag 24 is mounted to the generally perpendicular facing steering wheel 30, the oblique trajectory T′ for passenger air bag 25 is required due to the mounting requirement thereof on the generally horizontal instrument panel surface 32 and the adjacently disposed windshield 34.

Yet further, the “U” and “H” type automotive PSIR door systems are unique in that not only must such PSIR door systems operate for initial air bag deployment, such systems must also rapidly close after air bag deployment to limit the presence of any sharp edges in the instrument panel PSIR area prior to any potential secondary occupant collisions. PSIR door systems must also meet “out of position occupant” requirements, which are designed to reduce the danger to occupants that are closer to the instrument panel, or are out of their seated position. The out of position occupant requires the PSIR system to be placed closer to the windshield, where as discussed above, the instrument panel geometry is generally horizontal, resulting in the required oblique trajectory T′ for air bag deployment. Moreover, the out of position occupant requires the PSIR doors to be designed to induce minimal deflection to the air bag trajectory T′ by the rearward PSIR door 12, which is disposed in the path of the air bag.

It would therefore be of benefit to provide an economical and efficient method of deploying PSIR doors for facilitating adequate air bag deployment, and for further facilitating rapid PSIR door closure in the event of potential secondary occupant collisions. It would also be of benefit to provide a PSIR door design which induces minimal deflection to the air bag trajectory, and which is further beneficial to the overall PSIR operation.

### SUMMARY OF INVENTION

The invention overcomes the drawbacks and deficiencies of prior art PSIR door systems by providing a trapezoidal automotive PSIR door system including one or more lateral doors including two or more tear lines disposed at first and second oblique angles relative to a longitudinal direction of an automobile. The PSIR door system may further include a forward door including one or more tear lines in common with one of the lateral door tear lines, and a rearward door including one or more tear lines in common with another one of the lateral door tear lines.

For the trapezoidal automotive PSIR door system described above, the forward door may include a width in the longitudinal direction greater than the rearward door. The forward door may include an average length in a generally orthogonal direction relative to the longitudinal direction greater than the rearward door. In a particular embodiment, the lateral doors may include left and right side lateral doors. In a particular embodiment, the lateral door tear line in common with the forward door tear line is longer then the lateral door tear line in common with the rearward door tear line.

The invention also provides an automobile including a trapezoidal automotive PSIR door system including one or more lateral doors including two or more tear lines disposed at first and second oblique angles relative to a longitudinal direction of the automobile. The PSIR door system may further include a forward door including one or more tear lines in common with one of the lateral door tear lines, and a rearward door including one or more tear lines in common with another one of the lateral door tear lines.

For the automobile described above, the forward door may include a width in the longitudinal direction greater than the rearward door. The forward door may include an average length in a generally orthogonal direction relative to the longitudinal direction greater than the rearward door. In a particular embodiment, the lateral doors may include left and right side lateral doors. In a particular embodiment, the lateral door tear line in common with the forward door tear line is longer then the lateral door tear line in common with the rearward door tear line.

The invention also provides an automotive PSIR door system including one or more lateral doors including two or more tear lines disposed at first and second oblique angles relative to a longitudinal direction of the automobile. The PSIR door system may further include a forward door including one or more tear lines in common with one of the lateral door tear lines, and a rearward door including one or more tear lines in common with another one of the lateral door tear lines.

For the PSIR door system described above, the forward door may include a width in the longitudinal direction greater than the rearward door. The forward door may include an average length in a generally orthogonal direction relative to the longitudinal direction greater than the rearward door. In a particular embodiment, the lateral doors may include left and right side lateral doors. In a particular embodiment, the lateral door tear line in common with the forward door tear line is longer then the lateral door tear line in common with the rearward door tear line. Yet further, in a particular embodiment, the PSIR door may include a generally trapezoidal profile.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an illustration of an instrument panel including a conventionally mounted (vibration welded) air bag chute and corresponding forward and rearward Passenger Side Inflatable Restraint (PSIR) doors (H-pattern style);

FIG. 2 is a diagram illustrating the deployment characteristics of a driver's side mounted air bag;

FIG. 3 is a diagram illustrating the deployment characteristics of a PSIR air bag;

FIG. 4 is an illustration of a PSIR door configuration according to the present invention; and

FIG. 5 is a diagram illustrating the deployment characteristics of the PSIR air bag of FIG. 4.

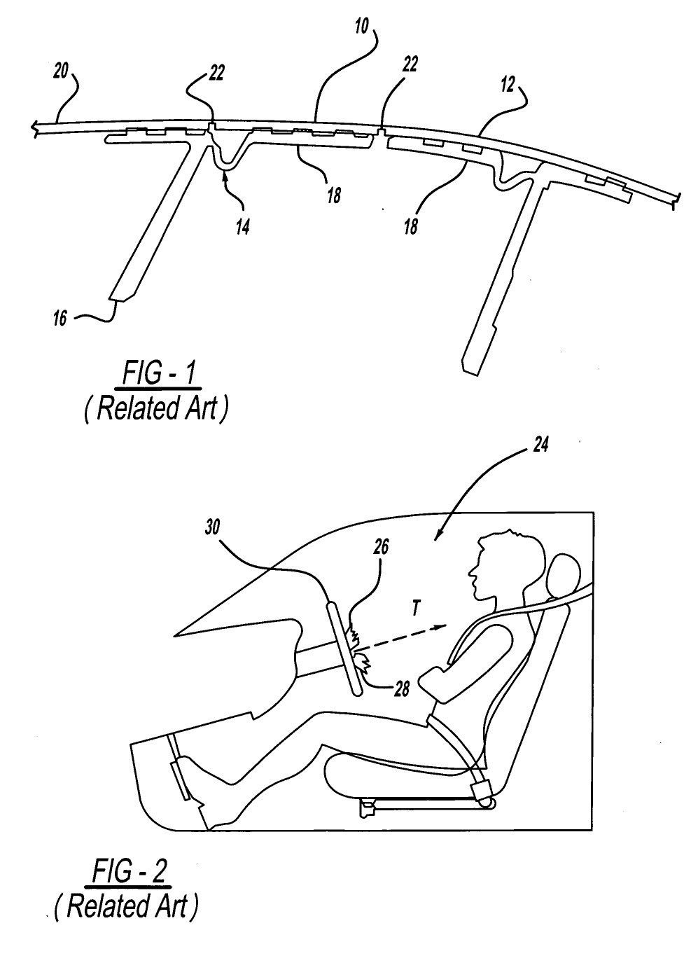

### DETAILED DESCRIPTION OF THE PREFERRED EMBODIMENTS

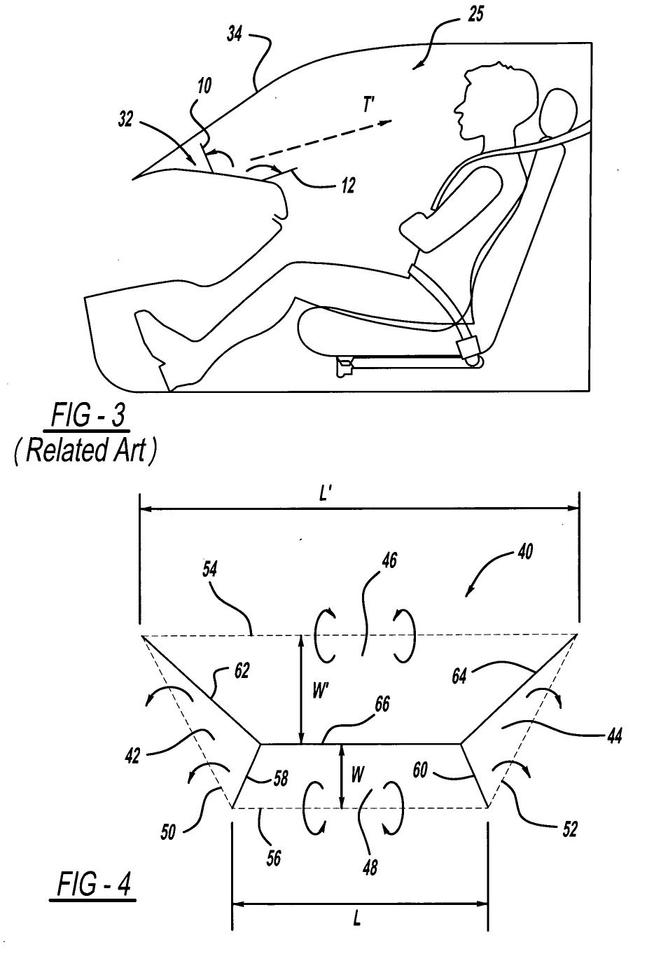

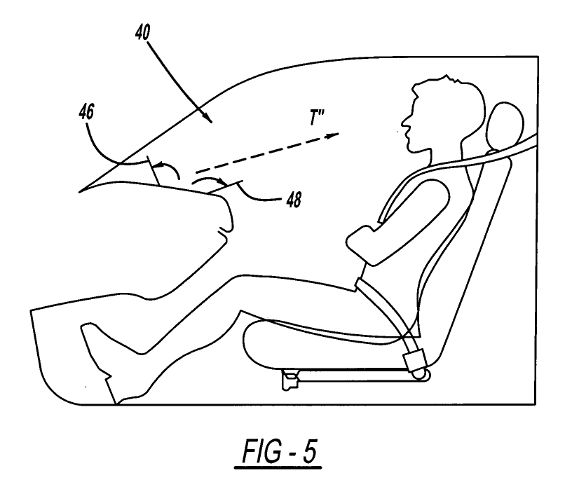

Turning now to the drawings wherein like reference characters refer to like and corresponding parts throughout the several views, FIGS. 4 and 5 illustrate various diagrams for the improved Passenger Side Inflatable Restraint PSIR) door configuration according to the present invention, generally designated trapezoidal PSIR door system 40.

Referring to FIGS. 4 and 5, trapezoidal PSIR door system 40 may generally include lateral doors 42, 44, forward door 46 and rearward door 48. Doors 42, 44, 46 and 48 may generally include respective hinges 50, 52, 54 and 56, and seams 58, 60, 62, 64 and 66. As clearly illustrated in FIGS. 4 and 5 (note doors 42, 44 omitted from FIG. 5 for clarity), forward and rearward doors 46, 48 may open in a similar manner as doors 10, 12 of the conventional “H” type automotive PSIR door system of FIG. 3. However, compared to the conventional “H” type automotive PSIR door system of FIG. 3, trapezoidal PSIR door system 40 includes several significant benefits. For example, referring to FIGS. 4 and 5, it can be seen that due to the shorter width W of rearward door 48 (compared to width W′ of forward door 46), rearward door 48 imparts minimal deflection to air bag trajectory T″ (see FIG. 5), and thus imparts a minimal obstruction in the path of the PSIR (not shown).

The aforementioned features of trapezoidal PSIR door system 40 are beneficial in that contrary to the conventional “H” type automotive PSIR door system of FIG. 3 which must deploy with a specific force and speed, the shorter width W of rearward door 48, which thus requires a shorter swing compared to rearward door 12 of FIG. 3, allows for the PSIR to be placed closer to the passenger, thus reducing the performance requirements of air bag systems.

The shorter width W of rearward door 48 is also beneficial in reducing air bag deflection. For example, due to staggering of the forward and rearward doors 46, 48 which have respective lengths L, L′, the longer forward door 46 tends to aid the air bag in its acute angle trajectory T″ (see FIG. 5), while the shorter rearward door 48 provides reduced resistance to the acutely angled air bag trajectory as the air bag passes the rearward door. Thus rearward door 48 is able to rotate a full 180° (or more) during air bag deployment.

Referring to FIG. 5, the shorter width W of rearward door 48, which reduces the opening and closing inertia thereof, is also beneficial in reducing the time required for door 48 to close. The improved closing time thus improves the smoothness of the instrument panel for thereby minimizing the aforementioned hazards associated with secondary occupant collisions.

Yet further, compared to conventional “U” or “H” shaped PSIR doors which respectively include one or two doors, trapezoidal PSIR door system 40 includes improved skin tear performance due to the provision of four doors 42, 44, 46 and 48 which include respective hinges 50, 52, 54 and 56.

Trapezoidal PSIR door system 40 thus provides an economical and efficient method of deploying PSIR doors for facilitating adequate air bag deployment, and for further facilitating rapid PSIR door closure in the event of potential secondary occupant collisions. Moreover, as discussed above, trapezoidal PSIR door system 40 also induces minimal deflection to the air bag trajectory, thus enabling placement of the PSIR door system closer to the passenger compartment.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A trapezoidal automotive PSIR door system comprising:
at least one lateral door including at least two tear lines disposed at first and second oblique angles relative to a longitudinal direction of an automobile;
a forward door including at least one tear line in common with one of said lateral door tear lines; and
a rearward door including at least one tear line in common with another one of said lateral door tear lines.

2. A trapezoidal automotive PSIR door system according to claim 1, wherein said forward door includes a width in the longitudinal direction greater than said rearward door.

3. A trapezoidal automotive PSIR door system according to claim 1, wherein said forward door includes an average length in a generally orthogonal direction relative to the longitudinal direction greater than said rearward door.

4. A trapezoidal automotive PSIR door system according to claim 1, wherein said lateral doors include left and right side lateral doors.

5. A trapezoidal automotive PSIR door system according to claim 1, wherein said lateral door tear line in common with said forward door tear line is longer then said lateral door tear line in common with said rearward door tear line.

6. An automobile including a trapezoidal automotive PSIR door system comprising.
at least one lateral door including at least two tear lines disposed at first and second oblique angles relative to a longitudinal direction of the automobile;
a forward door including at least one tear line in common with one of said lateral door tear lines; and
a rearward door including at least one tear line in common with another one of said lateral door tear lines.

7. An automobile according to claim 6, wherein said forward door includes a width in the longitudinal direction greater than said rearward door.

8. An automobile according to claim 6, wherein said forward door includes an average length in a generally orthogonal direction relative to the longitudinal direction greater than said rearward door.

9. An automobile according to claim 6, wherein said lateral doors include left and right side lateral doors.

10. An automobile according to claim 6, wherein said lateral door tear line in common with said forward door tear line is longer then said lateral door tear line in common with said rearward door tear line.

11. An automotive PSIR door system comprising:
at least one lateral door including at least two tear lines disposed at first and second oblique angles relative to a longitudinal direction of an automobile;
a forward door including at least one tear line in common with one of said lateral door tear lines; and
a rearward door including at least one tear line in common with another one of said lateral door tear lines.

12. An automotive PSIR door system according to claim 11, wherein said forward door includes a width in the longitudinal direction greater than said rearward door.

13. An automotive PSIR door system according to claim 11, wherein said forward door includes an average length in a generally orthogonal direction relative to the longitudinal direction greater than said rearward door.

14. An automotive PSIR door system according to claim 11, wherein said lateral doors include left and right side lateral doors.

15. An automotive PSIR door system according to claim 11, wherein said lateral door tear line in common with said forward door tear line is longer then said lateral door tear line in common with said rearward door tear line.

16. An automotive PSIR door system according to claim 11, wherein said PSIR door includes a generally trapezoidal profile.
